(19) United States
(12) Patent Application Publication
(10) Pub. No.: US 2005/0056710 A1
(43) Pub. Date: Mar. 17, 2005

(54) Fuel injection valve

(75) Inventors: Nobuaki Sekiya, Gunma (JP); Hiroshi Yamada, Gunma (JP)

Correspondence Address: SUGHRUE MION, PLLC, 2100 PENNSYLVANIA AVENUE, N.W., SUITE 800, WASHINGTON, DC, 20037, US

(73) Assignee: HITACHI UNISIA AUTOMOTIVE, LTD.

(21) Appl. No.: 10/919,355

(22) Filed: Aug. 17, 2004

(30) Foreign Application Priority Data
Sep. 12, 2003 (JP) 2003-320623

(51) Int. Cl. F02M 61/00

(52) U.S. Cl. 239/533.12

(57) ABSTRACT

A fuel injection valve includes a valve seat having a valve-seat portion on which a valve element is seated, and a nozzle plate disposed downstream from the valve seat and having a plurality of nozzle holes. A deformable member deforms with temperature to vary a space between the valve-seat portion of the valve seat and the nozzle plate, thus achieving change in spray characteristics.

### BACKGROUND OF THE INVENTION

The present invention relates to a fuel injection valve for injecting fuel into an internal combustion engine, and more particularly, to a fuel injection valve provided with a mechanism for varying the spray characteristics.

As disclosed in Japanese document P2000-104647A, the typical fuel injection valve comprises a valve element, a valve seat on which the valve element is seated, and a nozzle plate disposed downstream from the valve seat and having a plurality of nozzle holes.

### SUMMARY OF THE INVENTION

When carrying out fuel injection into intake ports, for example, by varying a site of an intake valve struck by injected fuel in accordance with the engine operating conditions, an improvement can be achieved in combustibility and thus exhaust emission. However, with the typical fuel injection valve, the spray angle of fuel injected from the nozzle holes of the nozzle plate is fixed at a given angle determined in accordance with passage axes of the nozzle holes and at which exhaust emission can be improved in an average way. This does not allow setting of an optimum spray angle in accordance with the engine operating conditions for the purpose of achieving maximum improvement in exhaust emission.

It is, therefore, an object of the present invention to provide a fuel injection valve which allows change in spray characteristics, particularly, spray angle, of the fuel injection valve and thus contributes to improvement in exhaust emission of the engine.

The present invention provides generally a fuel injection valve, which comprises: a valve element; a valve seat comprising a valve-seat portion on which the valve element is seated; a nozzle plate disposed downstream from the valve seat, the nozzle plate having a plurality of nozzle holes; and a device which varies a space between the valve-seat portion of the valve seat and the nozzle plate to achieve a change in spray characteristics.

### BRIEF DESCRIPTION OF THE DRAWINGS

The other objects and features of the present invention will becomes apparent from the following description with reference to the accompanying drawings, wherein:

FIG. 1 is a sectional view showing a first embodiment of a fuel injection valve according to the present invention;

FIG. 2 is a fragmentary enlarged sectional view of the front end of the fuel injection valve in FIG. 1;

FIG. 3 is a view similar to FIG. 2, showing the front end of the fuel injection valve in FIG. 1;

FIG. 4 is a view similar to FIG. 3, showing a second embodiment of the present invention;

FIG. 5 is a view similar to FIG. 4, showing the second embodiment of the present invention;

FIG. 6 is a view similar to FIG. 5, showing a third embodiment of the present invention; and

FIG. 7 is a view similar FIG. 6, showing a fourth embodiment of the present invention.

### DETAILED DESCRIPTION OF THE INVENTION

Referring to the drawings wherein like references designate like parts throughout the views, a description will be made about preferred embodiments of a fuel injection valve according to the present invention. In the preferred embodiments, the fuel injection valve serves to supply fuel to an internal combustion engine (gasoline engine).

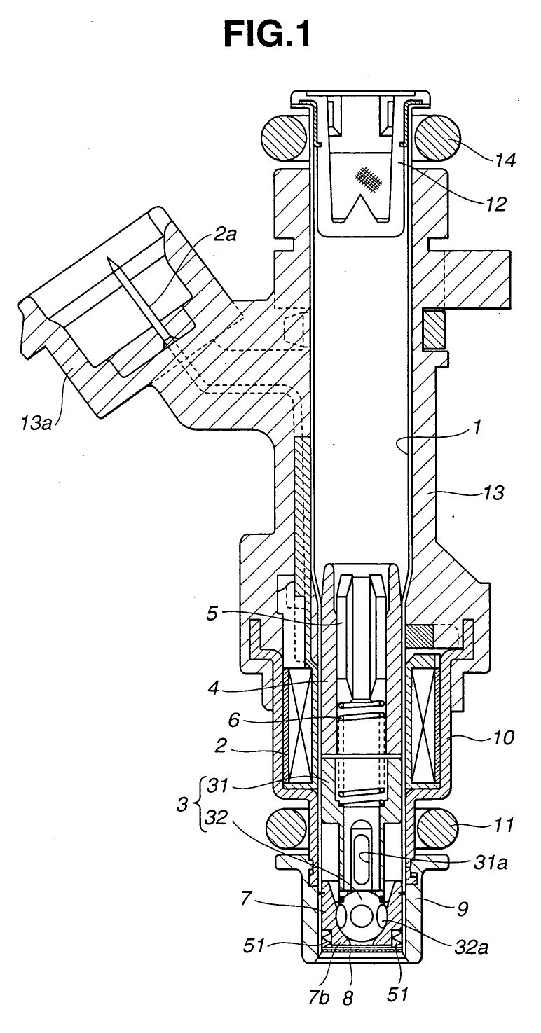

Referring to FIGS. 1-3, there is shown first embodiment of the present invention. Referring to FIG. 1, the fuel injection valve comprises a casing pipe 1 made of a magnetic material, an electromagnetic coil 2 fixedly mounted on the outer periphery of casing pipe 1, and a valve element 3 axially slidably arranged through casing pipe 1 and including a tubular anchor 31 and a ball 32 integrated together by welding.

A fuel passage opening 31a is formed in the lower peripheral wall of anchor 31, and a plurality of flat surfaces 32a are provided on the periphery of ball 32 by machining. Fuel flowing outward of anchor 31 through fuel passage opening 31a runs toward the front end of the fuel injection valve through a clearance between flat surfaces 32a and the inner wall of a valve seat 7 as will be described later. A tubular spring housing 4 is fixedly mounted on the inner wall of casing 1 above valve element 3 (anchor 31) as viewed in FIG. 1 with a predetermined clearance provided therebetween.

A tubular spring stopper 5 is fixedly arranged through spring housing 4, and a return spring 6 is compressedly interposed between the lower end of spring stopper 5 and a stepped portion of anchor 31. Valve seat 7 having in the center an injection hole is connected to the inner periphery of the lower end of casing pipe 1 by welding so as to seat ball 32 of valve element 3. A nozzle plate 8 having a plurality of nozzle holes 8a is disposed at the lower end of (downstream from) valve seat 7.

A cap 9 is mounted on the outer periphery of the lower end of casing pipe 1, and a coil cover 10 for covering the outside of electromagnetic coil 2 has a lower end connected to casing pipe 1 by welding. A seal member 11 is arranged between an upper-end flange of cap 9 and the stepped portion of coil cover 10.

A fuel filter 12 is fixedly engaged in the upper end of casing pipe 1.

A resin envelope 13 is formed by molding subjected to a portion extending from the upper end of coil cover 10 to that of casing pipe 1 and a portion corresponding to electromagnetic coil 2 except an end of a lead 2a. A seal member 14 is arranged between the upper end face of envelope 13 and the upper-end flange face of casing pipe 1.

Envelope 13 is formed with a connector 13a obtained by surrounding the end of lead 2a of electromagnetic coil 2. During non-energization of electromagnetic coil 2, the fuel injection valve is closed with valve element 3 seated on a seating face of valve seat 7 by a resilient compressive force of return spring 6. When energizing electromagnetic coil 2, valve element 3 is lifted by a magnetic attraction against a resilient biasing force of return spring 6 to separate from the seating face of valve seat 7, obtaining opening of the fuel injection valve.

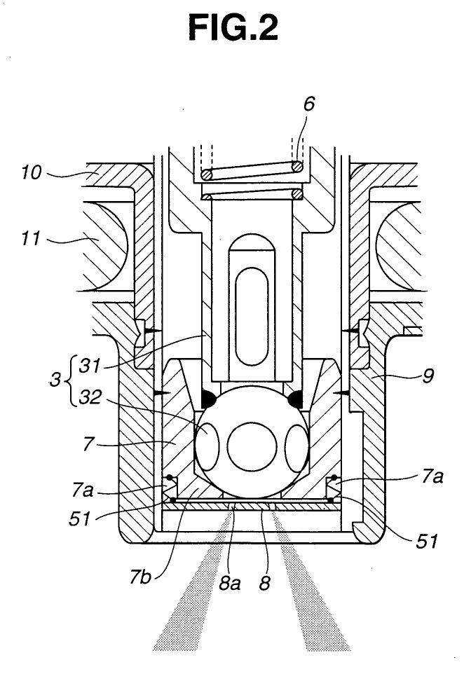

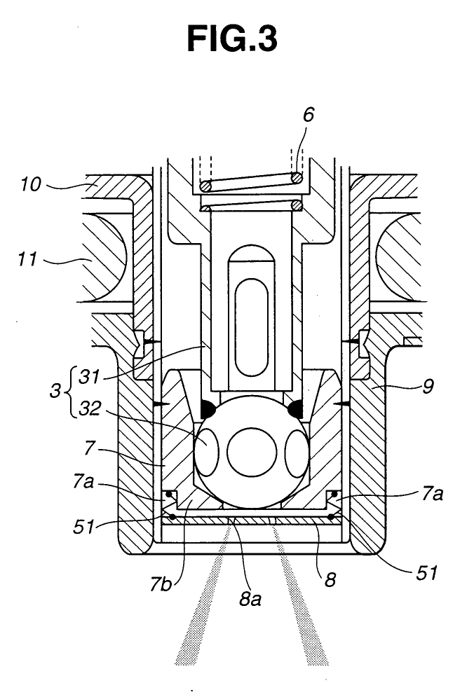

Nozzle plate 8 is not integrally mounted to valve seat 7, but axially displaceably supported with valve seat 7 as a fixed end. Referring to FIGS. 2 and 3, a deformable member 51 is accommodated in a recess 7a arranged in the outer periphery of the lower end of valve seat 7. Deformable member 51 has one end mounted to the end face of recess 7a and another end mounted to the end face of nozzle plate 8.

Deformable member 51 is formed of a shape memory alloy which varies its shape with temperature, and thus expands and contracts in the axial direction of the fuel injection valve with temperature. Without being mounted to either of casing pipe 1 and valve seat 7, nozzle plate 8 is arranged in casing pipe 1 to be axially displaceable in making slide contact with the inner peripheral wall thereof. Thus, nozzle plate 8 moves parallel in the axial direction of the fuel injection valve in accordance with deformation of deformable member 51, achieving change in distance between the lower end of valve seat 7 and nozzle plate 8, i.e. space between a valve-seat portion 7b of valve seat 7 and nozzle plate 8.

When the distance between the lower end of valve seat 7 and nozzle plate 8, i.e. the space between valve-seat portion 7b of valve seat 7 and nozzle plate 8 varies, the relative angle between the fuel flow direction and nozzle holes 8a varies, achieving change in spray angle as one of the spray characteristics as shown in FIGS. 2 and 3. Then, the fuel injection valve can be constructed such that, under the high-temperature conditions, deformable member 51 contracts as shown in FIG. 2 to have valve seat 7 close to nozzle plate 8, whereas, under the low-temperature conditions, deformable member 51 expands as shown in FIG. 3 to have valve seat 7 separate from nozzle plate 8. Alternatively, the fuel injection valve may be constructed such that, under the high-temperature conditions, valve seat 7 is separate from nozzle plate 8 as shown in FIG. 3, whereas, under the low-temperature conditions, valve seat 7 is close to nozzle plate 8 as shown in FIG. 2.

In the first embodiment, the fuel injection valve can be constructed such that deformable member 51 deforms with change in environmental temperature of the valve produced in accordance with, e.g. the engine operating conditions such as load and rotation, achieving change in spray angle. By way of example, by setting the deformation characteristics, i.e. thermal expansion or contraction and deformation amount of deformable member 51 in accordance with the spray angle required under the engine high-load conditions where the temperature becomes higher, an optimum spray angle can be achieved in response to the temperature conditions.

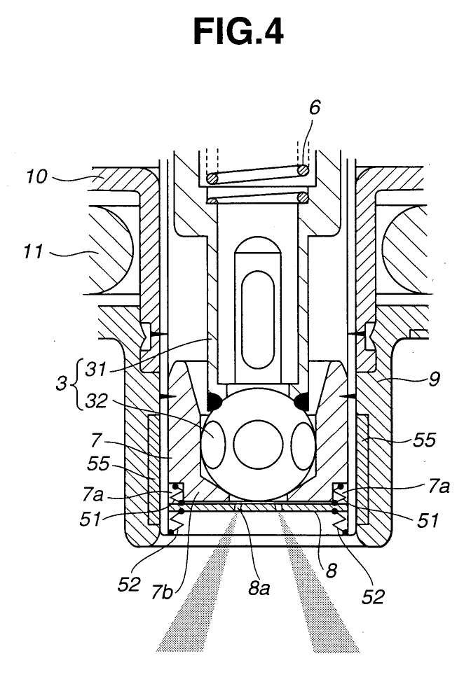

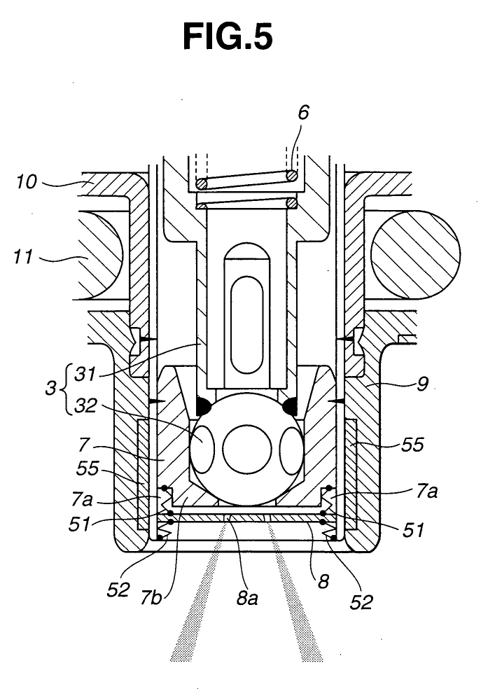

Referring to FIGS. 4 and 5, there is shown second embodiment of the present invention. In the second embodiment, a return spring or resilient member 52 is arranged between casing pipe 1 and nozzle plate 8 to bias nozzle plate 8 toward its reference position (i.e. position shown in FIG. 4). This structure allows enhancement in deformation response of deformable member 51 in accordance with the temperature conditions.

Moreover, in the second embodiment, a heater 55 is integrally provided to the inside of cap 9 to heat deformable member 1. This structure allows control of the temperature conditions of deformable member 51 by controlling energization of heater 55 in accordance with the required spray angle, thus achieving control of the displacement amount or position of nozzle plate 8, resulting in change in spray angle with higher flexibility.

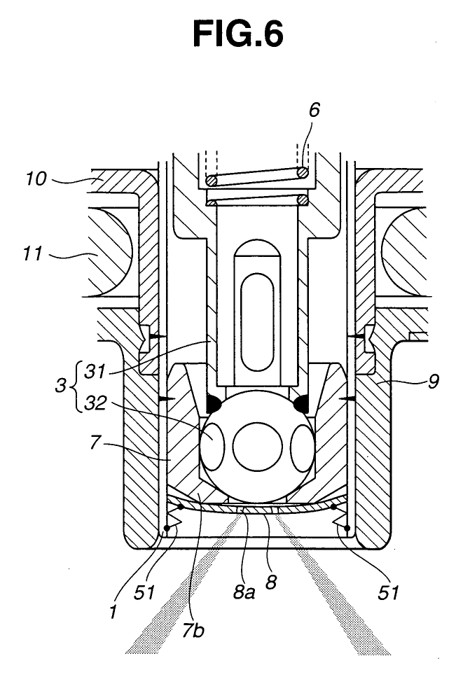

Referring to FIG. 6, there is shown third embodiment of the present invention. In the third embodiment, deformable member 51 is supported to casing pipe 1 as a fixed end. As distinct from the first and second embodiments, in the third embodiment, the fuel injection valve is constructed such that, when deformable member 51 expands, valve seat 7 is close to nozzle plate 8 with, whereas, when it contracts, valve seat 7 is separate from nozzle plate 8. Alternatively, the fuel injection valve may be constructed such that, when deformable member 51 expands, nozzle plate 8 is pressed against valve seat 7 to have the center portion with nozzle holes 8a deformed, achieving change in spray angle.

In the above embodiments, deformable member 51 is formed of a shape memory alloy which varies its shape with temperature. Optionally, deformable member 51 may include a member which deforms by voltage such as a piezo-electric element or a member which deforms by magnetic force such as a magnetostrictive element. The use of a piezo-electric element or a magnetostrictive element as deformable member 51 allows arbitrary and continuous control of the displacement of nozzle plate 8 with accuracy.

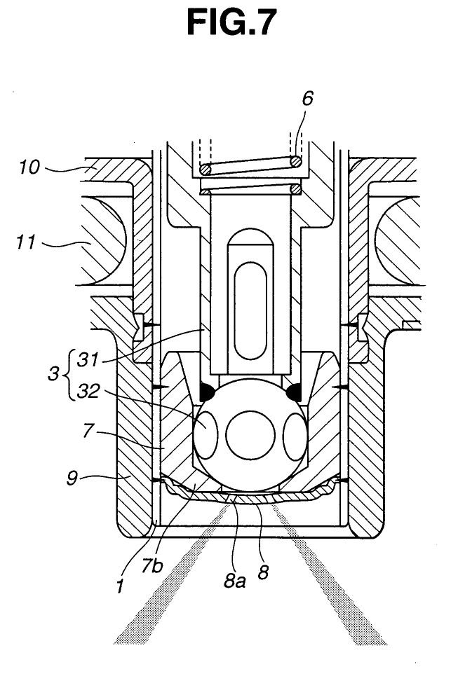

Referring to FIG. 7, there is shown fourth embodiment of the present invention. In the forth embodiment, nozzle plate 8 itself is formed of a shape memory alloy. The peripheral edge of nozzle plate 8 formed of a shape memory alloy is connected to the inner peripheral wall of casing pipe 1. The outer periphery of nozzle plate 8 deforms in accordance with the temperature to have the center portion with nozzle holes 8a moving parallel.

In the fourth embodiment, the outer periphery of nozzle plate 8 deforms in accordance with the temperature to achieve change in distance between valve seat 7 and the center portion of nozzle plate 8 having nozzle holes 8a, i.e. space between valve-seat portion 7b of valve seat 7 and nozzle plate 8, thus achieving change in spray angle.

When nozzle plate 8 is formed of a shape memory alloy, the portions for defining nozzle holes 8a are constructed to be deformable also, thereby achieving change not only in the space between valve-seat portion 7b of valve seat 7 and nozzle plate 8, but also in shape itself of nozzle holes 8a, thus achieving change in spray characteristics.

Moreover, in the fourth embodiment, the heater can be arranged to control the temperature of nozzle plate 8 formed of a shape memory alloy.

As described above, according to the present invention, by changing a space between the valve-seat portion of the valve seat and the nozzle plate, the relative angle of the nozzle holes with respect to the fuel flow direction, thus achieving change in spray characteristics, particularly, spray angle. Therefore, change in space between the valve-seat portion of the valve seat and the nozzle plate allows change in spray characteristics in accordance with the engine operating conditions.

Further, according to the present invention, when the deformable member deforms, the nozzle plate is displaced accordingly, changing a space between the valve-seat portion of the valve seat and the nozzle plate, thus achieving change in spray characteristics. Therefore, the spray characteristics can be changed in accordance with change in deformation conditions of the deformable member or control of the deformation conditions thereof, resulting in possible change in spray characteristics in accordance with the engine operating conditions.

Still further, according to the present invention, the spay characteristics are changed by change in space between the valve-seat portion and the nozzle plate and/or deformation of the nozzle holes due to deformation of the nozzle plate. Therefore, deformation of the nozzle plate allows change in spray characteristics in accordance with the engine operating conditions.

Furthermore, according to the present invention, the nozzle plate can be displaced in accordance with temperature (shape memory alloy), voltage (piezo-electric element), or magnetic force (magnetostrictive element).

Further, according to the present invention, the resilient member biases the nozzle plate toward its reference position, resulting in enhanced deformation response when the deformable member deforms toward the reference position.

Further, according to the present invention, the temperature conditions of the deformable member or the nozzle plate which deform with temperature can actively be changed by energization control of the heater, resulting in possible change in spray characteristics with higher flexibility.

Having described the present invention in connection with the illustrative embodiments, it is noted that the present invention is not limited thereto, and various changes and modifications can be made without departing from the scope of the present invention.

The entire teachings of Japanese Patent Application P2003-320623 filed Sep. 12, 2003 are hereby incorporated by reference.

1. A fuel injection valve, comprising:
a valve element;
a valve seat comprising a valve-seat portion on which the valve element is seated;
a nozzle plate disposed downstream from the valve seat, the nozzle plate having a plurality of nozzle holes; and
a device which varies a space between the valve-seat portion of the valve seat and the nozzle plate to achieve a change in spray characteristics.

2. The fuel injection valve as claimed in claim 1, wherein the device comprises a deformable member which deforms under a predetermined condition.

3. The fuel injection valve as claimed in claim 1, wherein the device is accommodated in a recess arranged in an outer periphery of a lower end of the valve seat, wherein the device has one end mounted to an end face of the recess and another end mounted to an end face of the nozzle plate.

4. The fuel injection valve as claimed in claim 2, wherein the deformable member is formed of one of a shape memory alloy, a piezo-electric element, and a magnetostrictive element.

5. The fuel injection valve as claimed in claim 1, further comprising a resilient member arranged between a casing of the fuel injection valve and the nozzle plate and biasing the nozzle plate toward its reference position, and a heater heating the deformable member.

6. The fuel injection valve as claimed in claim 1, wherein the device is disposed downstream from the valve seat and the nozzle plate, the device being supported to a casing of the fuel injection valve as a fixed end.

7. The fuel injection valve as claimed in claim 1, wherein the nozzle plate is formed of a shape memory alloy which varies its shape with temperature.

8. The fuel injection valve as claimed in claim 7, further comprising a heater heating the nozzle plate.

9. A fuel injection valve, comprising:
a valve element;
a valve seat comprising a valve-seat portion on which the valve element is seated;
a nozzle plate disposed downstream from the valve seat, the nozzle plate having a plurality of nozzle holes; and
means for varying a space between the valve-seat portion of the valve seat and the nozzle plate to achieve a change in spray characteristics.
